(19) United States
(12) Patent Application Publication
(10) Pub. No.: US 2009/0224498 A1
(43) Pub. Date: Sep. 10, 2009

(54) Wire and Cable Assembly Device and Associated Methods

(76) Inventor: Johannes P. L. Diedericks, Monroe, GA (US)

Correspondence Address: GEORGE R. REARDON, 3356 STATION COURT, LAWRENCVILLE, GA, 30044, US

(21) Appl. No.: 12/044,583

(22) Filed: Mar. 7, 2008

(51) Int. Cl. B62B 3/10

(52) U.S. Cl. 280/79.6

(57) ABSTRACT

The technology described herein provides a wire and cable assembly device and associated methods for holding multiple spools of wound material, such as electrical, telephone, fiber optic cables, or the like, for selective dispensing. The technology described also provides a portable, foldable, and adaptable wire and cable assembly device to facilitate the installation of wire and cable products in a building, parking lot, or the like. The device is transportable both manually and by a means of towing.

### FIELD OF THE INVENTION

The technology described herein relates generally to a wire and cable assembly device and associated methods for holding multiple spools of wound material, such as electrical, telephone, fiber optic cables, or the like, for selective dispensing. More specifically, the technology described herein relates to a portable, foldable, and adaptable wire and cable assembly device to facilitate the installation of wire and cable products in a building, parking lot, or the like, wherein the device is transportable both manually and by a means of towing.

### BACKGROUND OF THE INVENTION

In the construction and wiring industries it is often necessary to selective dispense wires or cables, such as electrical, telephone, fire alarm, controls, fiber optic cables, or the like, as a bundle or group of differing wire types, or to have available a multiplicity of various wire types on a regular basis for use at an installation site. By way of example, such a device can assist significantly in the wire-pulling process inside a building or in a parking lot.

These and other problems exist. Previous attempts to solve these and other problems include the following. U.S. Pat. No. 2,705,114, issued to Worsham on Mar. 29, 1955, discloses a reel carrying rack. U.S. Pat. No. 3,072,357, issued to Sprague et al. on Jan. 8, 1963, discloses a multiple wire cable support. U.S. Pat. No. 3,134,555, issued to Baker on May 26, 1964, discloses a carrying and dispensing device for spool mounted wire. U.S. Pat. No. 3,603,526, issued to Payne et al. on Sep. 7, 1971, discloses a portable wire holder rack. U.S. Pat. No. 3,854,509, issued to Bailey on Dec. 17, 1974, discloses a mobile reel support unit. U.S. Pat. No. 3,856,230, issued to Zimmer on Dec. 24, 1974, discloses a wire dispensing cart. U.S. Pat. No. 4,391,422, issued to McDonald on Jul. 5, 1983, discloses a weight balanced spool carrier. U.S. Pat. No. 4,564,152, issued to Herriage on Jan. 14, 1986, discloses an apparatus for storing and transporting wire on reels and for dispensing wire from reels. U.S. Pat. No. 5,275,349, issued to Tussing on Jan. 4, 1994, discloses a cart for spools of wire. U.S. Pat. No. 5,308,012, issued to Fuller on May 3, 1994, discloses a folding wirecart convertible into float and handtruck. U.S. Pat. No. 5,316,232, issued to Lambert, Jr. on May 31, 1994, discloses an omnidirectional wire dispenser. U.S. Pat. No. 5,509,671, issued to Campbell on Apr. 23, 1996, discloses a cart for carrying spools of wire. U.S. Pat. No. 5,687,928, issued to Lassiter on Nov. 18, 1997, discloses a rack for wire dispensing spools. U.S. Pat. No. 5,915,646, issued to Campbell on Jun. 29, 1999, discloses a cart for carrying spools of wire and utility trays. U.S. Pat. No. 6,270,094, issued to Campbell on Aug. 7, 2001, discloses a multi-purpose wire dispensing cart. U.S. Pat. No. 6,422,504, issued to Elder on Jul. 23, 2002, discloses a wire spool cart. U.S. Pat. No. 6,523,776, issued to Elder on Feb. 25, 2003, discloses a wire dispensing device. U.S. Pat. No. 6,698,682, issued to Roderick on Mar. 2, 2004, discloses a mobile wire dispensing apparatus. U.S. Pat. No. 6,877,753, issued to Anderson et al. on Apr. 12, 2005, discloses a reel support and dispensing cart. U.S. Pat. No. 6,951,316, issued to Heidelberger on Oct. 4, 2005, discloses a towable dispenser system. U.S. Pat. No. 7,150,459, issued to Anderson et al. on Dec. 19, 2006, discloses a reel support and dispensing cart. U.S. Pat. No. 7,243,876, issued to Robison on Jul. 17, 2007, discloses a method and apparatus for handling wire spools. U.S. Pat. No. D182,483, issued to Skinner on Apr. 8, 1959, discloses the ornamental design for a truck for the storage and transport of folding chairs and other articles. U.S. Pat. No. D269,388, issued to Smith et al. on Jun. 14, 1983, discloses the ornamental design for a wire handling cart.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a wire and cable assembly device and associated methods for holding multiple spools of wound material, such as electrical, telephone, fiber optic cables, or the like, for selective dispensing. The technology described also provides a portable, foldable, and adaptable wire and cable assembly device to facilitate the installation of wire and cable products in a building, parking lot, or the like. The device is transportable both manually and by a means of towing.

In one exemplary embodiment, the technology described herein provides a wire and cable assembly device for selectively dispensing a multiplicity of wire and cable products. The device includes a frame comprising a c-frame section being vertical and an h-frame section being horizontal and upon which the c-frame section perpendicularly is disposed and slidably adjustable, the c-frame section and the h-frame section being separable from one another for portability and storage and a plurality of spool support rods disposed throughout the c-frame section for holding spools of wire and cable products for dispensing.

The device also includes a plurality of support bridges disposed upon the h-frame section configured to receive the c-frame section through the plurality of support bridges and a plurality of hand knobs, one of the plurality of hand knobs being disposed upon each of the plurality of support bridges. The h-frame section is further comprised of a front, center, and back section, integrally formed, the plurality of support bridges being disposed upon the h-frame center section. The c-frame section is further comprised of a top, center, and bottom section and a gusset, integrally formed, and a plurality of holes disposed through the c-frame top and c-frame center sections and within which to receive the plurality support rods. The c-frame bottom section is disposed upon the h-frame center section and held in place by the plurality of support bridges and tightened by the plurality of hand knobs.

The device further includes a c-frame bottom section with a towing hitch end for connectivity of the wire and cable assembly device to a motor vehicle, or the like, and a towing hitch end pin hole configured to receive a hitch pin. The device further includes a plurality of wheels, the wheels being disposed on an underside of the h-frame section and secured with a plurality of retaining rings and configured to spin 360 degrees on a swiveled wheel frame and to be selectively locked in place with a brake to prevent overall movement of the wire and cable assembly device.

The device also includes a plurality of snap rings, one snap ring being disposed at each end of each of the plurality of spool support rods, the snap rings configured to hold in place a spool such that the spool freely rotates as a wire or cable product is dispensed but that the spool does not come off the support rod. The plurality of spool support rods is comprised of rods of varying diameters such that those rods of a smaller diameter are configured for storage within those rods of a larger diameter, and wherein the snap ring being disposed at each end of each of the plurality of spool support rods prevents a rod of smaller diameter stored within from falling out of the rod of larger diameter.

The device further includes a plurality of hex bolts utilized to secure the support rods of a larger diameter, wherein one of the plurality of hex bolts is tightened once one the support rods of a larger diameter is threaded through the c-frame section. The device also includes a plurality of support rod hand knobs disposed on the c-frame section and utilized to secure the support rods of a smaller diameter, wherein one of the plurality of support rod hand knobs is tightened once one of the support rods of a smaller diameter is threaded through the c-frame section, thus providing for ease and rapid removal of the support rods of a smaller diameter when not in use to store them within the support rods of a larger diameter.

In various embodiments, the plurality of spool support rods is zinc-coated to prevent rust and to provide durability. A width of the h-frame section and a width of each of the plurality of support rods is configured and limited such that the wire and cable assembly device freely passes through doorways of standard industry size. The c-frame section and the h-frame section are comprised of square tubing members that are integrally formed. The plurality of spool support rods is comprised of hollow cylindrical metal tubes configured to hold a plurality of spools containing various wire and cable products, each spool placed securely on one of the plurality of support rods.

In another exemplary embodiment, the technology described herein provides a method for assembling a wire and cable assembly device for selectively dispensing a multiplicity of wire and cable products. The method includes providing an h-frame section comprising a front, center, and back section, integrally formed, a plurality of support bridges disposed upon the h-frame center section configured to receive the c-frame section through the plurality of support bridges, and a plurality of hand knobs, one of the plurality of hand knobs being disposed upon each of the plurality of support bridges, providing a c-frame section comprising a top, center, and bottom section and a gusset, integrally formed, and comprising a plurality of holes, providing a plurality of wheels, each of the plurality of wheels configured to spin 360 degrees and to be selectively locked in place to prevent movement of the wire and cable assembly device, providing a plurality of spool support rods disposed throughout the holes of the c-frame section for holding spools of wire and cable products for dispensing, interconnecting and retaining the plurality of wheels to the underside of the h-frame section, interconnecting the c-frame section to the h-frame section, threading the c-frame bottom section through the plurality of support bridges and tightening the plurality of hand knobs, securing the c-frame section to the h-frame section, and threading the plurality of spool support rods through a plurality of holes on the c-frame section.

The method also includes providing a c-frame bottom section further comprising a towing hitch end for connectivity of the wire and cable assembly device to a motor vehicle, or the like and a towing hitch end pin hole configured to receive a hitch pin, and interconnecting the towing hitch end to the motor vehicle.

The method also includes providing a plurality of snap rings configured to hold in place a spool such that the spool freely rotates as a wire or cable product is dispensed but that the spool does not come off the support rod and placing one snap ring at each end of each of the plurality of spool support rods to secure a spool. The plurality of spool support rods is comprised of rods of varying diameters such that those rods of a smaller diameter are configured for storage within those rods of a larger diameter, and wherein the snap ring being disposed at each end of each of the plurality of spool support rods prevents a rod of smaller diameter stored within from falling out of the rod of larger diameter.

The method also includes providing a plurality of hex bolts and securing the support rods of a larger diameter with the plurality of hex bolts, wherein one of the plurality of hex bolts is tightened once one the support rods of a larger diameter is threaded through the c-frame section. The method also includes providing a plurality of support rod hand knobs and securing the support rods of a smaller diameter with the plurality of support rod hand knobs, wherein one of the plurality of support rod hand knobs is tightened once one of the support rods of a smaller diameter is threaded through the c-frame section, thus providing for ease and rapid removal of the support rods of a smaller diameter when not in use to store them within the support rods of a larger diameter.

The method further includes removing any spools located on the plurality of spool support rods, removing the plurality of spool support rods from the c-frame section, disconnecting the c-frame section from the h-frame section, and storing and/or transporting the wire and cable assembly device

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a back perspective view of the wire and cable assembly device according to an embodiment of the technology, illustrating, in particular, the placement of a spool on one of the spool supports;

FIG. 2 is the back perspective view of the wire and cable assembly device depicted in FIG. 1, illustrated without a spool;

FIG. 3 is a front perspective view of the wire and cable assembly device depicted in FIG. 2;

FIGS. 4 and 5 are expanded rear perspective views of the wire and cable assembly device depicted in FIG. 2, illustrating, in particular, the h-frame assembly, the c-frame assembly, and their associated interconnectedness and placement of spool supports in the c-frame, according to an embodiment of the technology; and

FIGS. 6 and 7 are expanded front perspective views of the wire and cable assembly device depicted in FIG. 2, illustrating, in particular, the h-frame assembly, the c-frame assembly, and their associated interconnectedness and placement of spool supports in the c-frame, according to an embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a wire and cable assembly device and associated methods for holding multiple spools of wound material, such as electrical, telephone, fiber optic cables, or the like, for selective dispensing. The technology described also provides a portable, foldable, and adaptable wire and cable assembly device to facilitate the installation of wire and cable products in a building, parking lot, or the like. The device is transportable both manually and by a means of towing. Additionally, the device is capable of being completely disassembled to be placed in a gang box or the trunk of a vehicle for storage or transportation. The device is capable of supporting spools of wire or cable product such as, for example, small spools of 500 feet (cable length) to 1000 feet or large spools of up to 2500 feet.

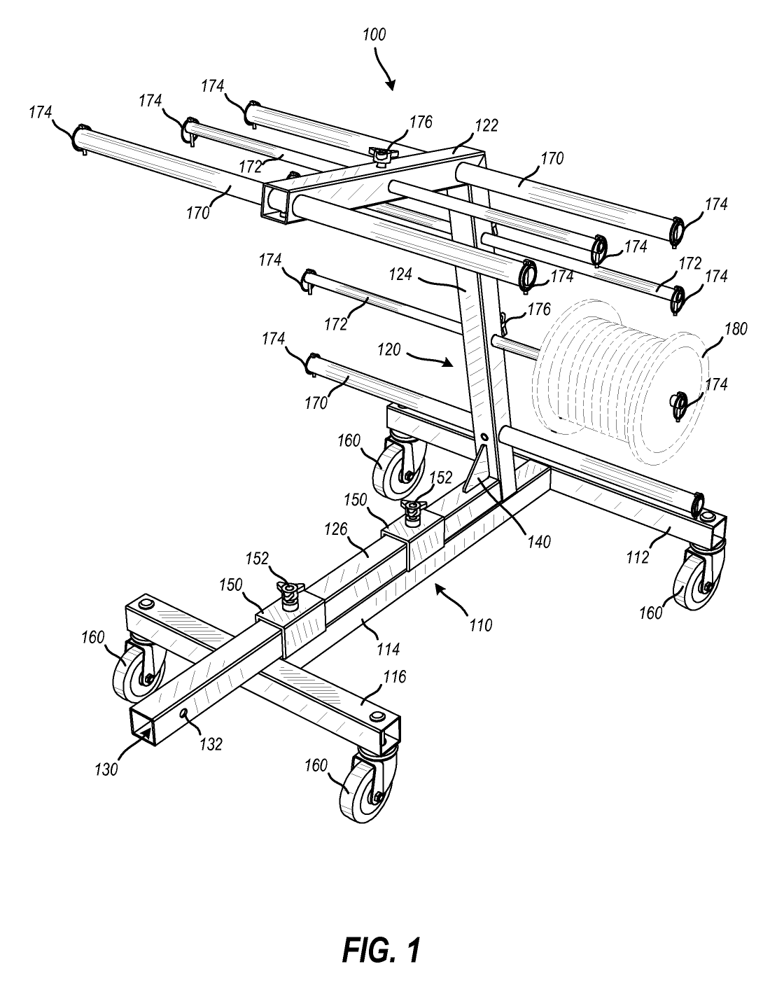

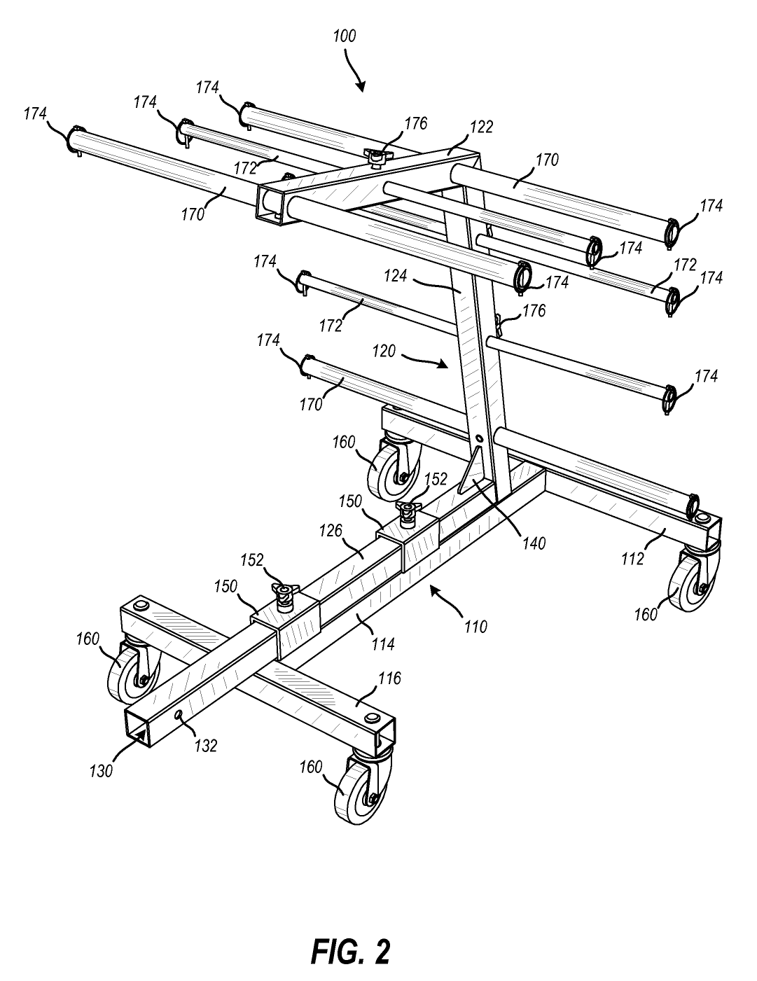

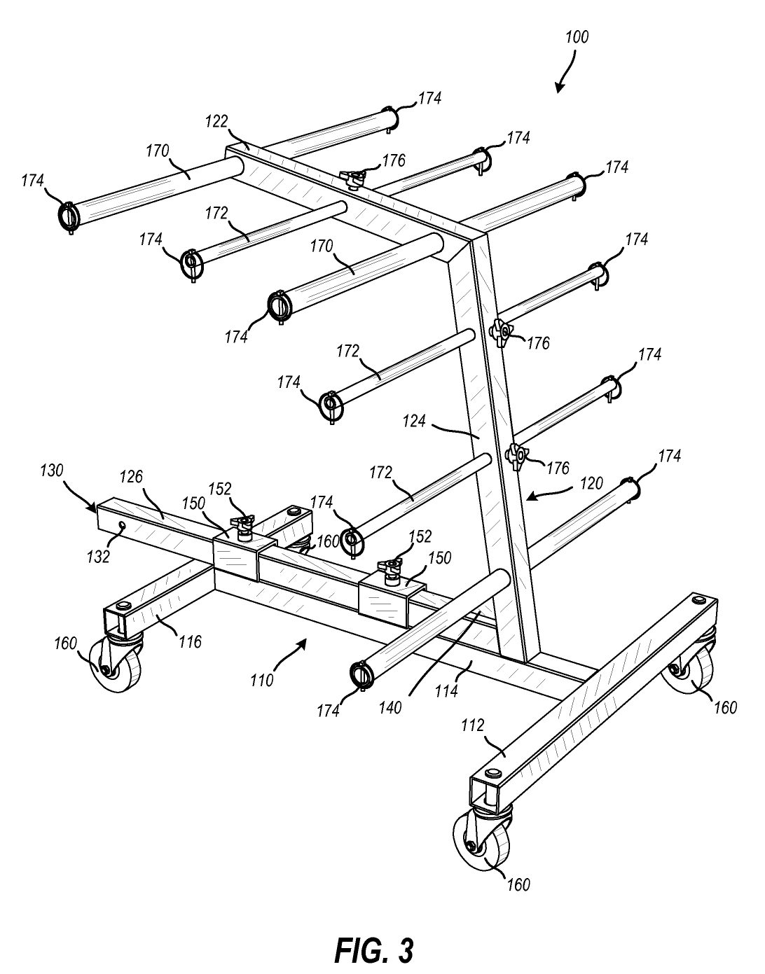

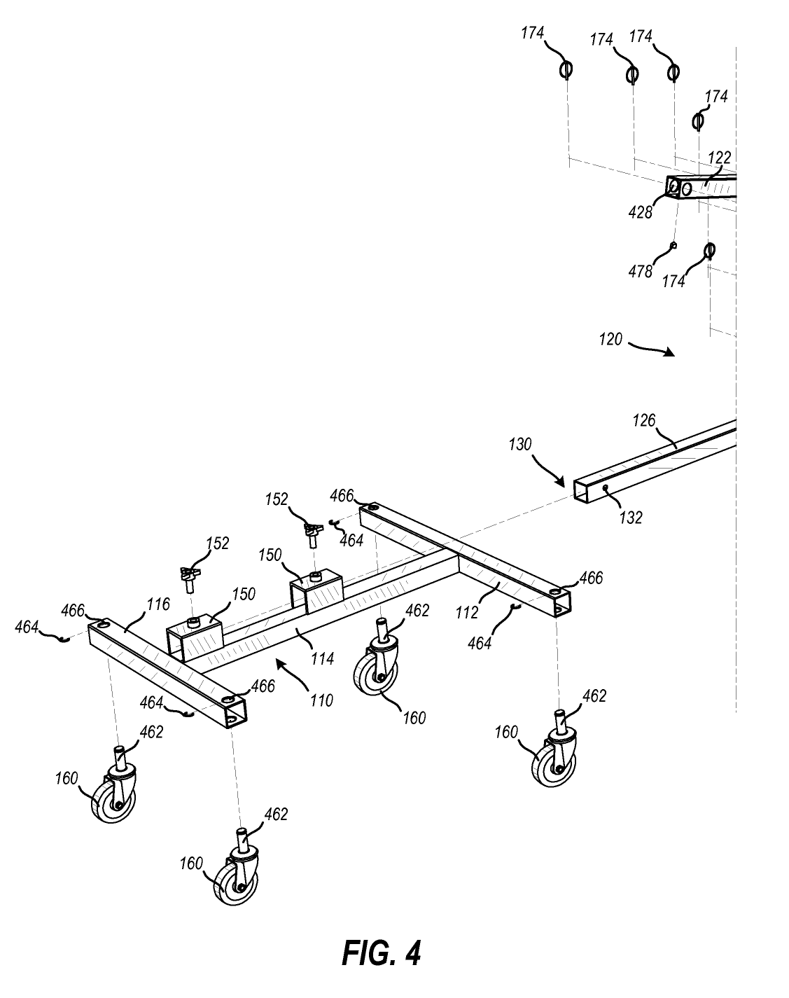

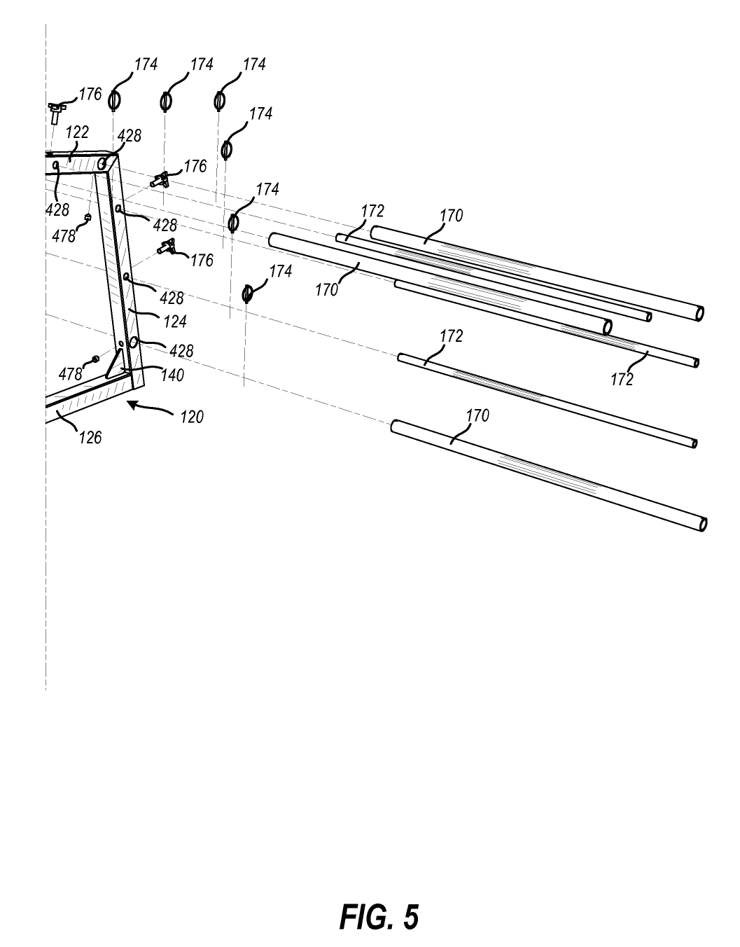

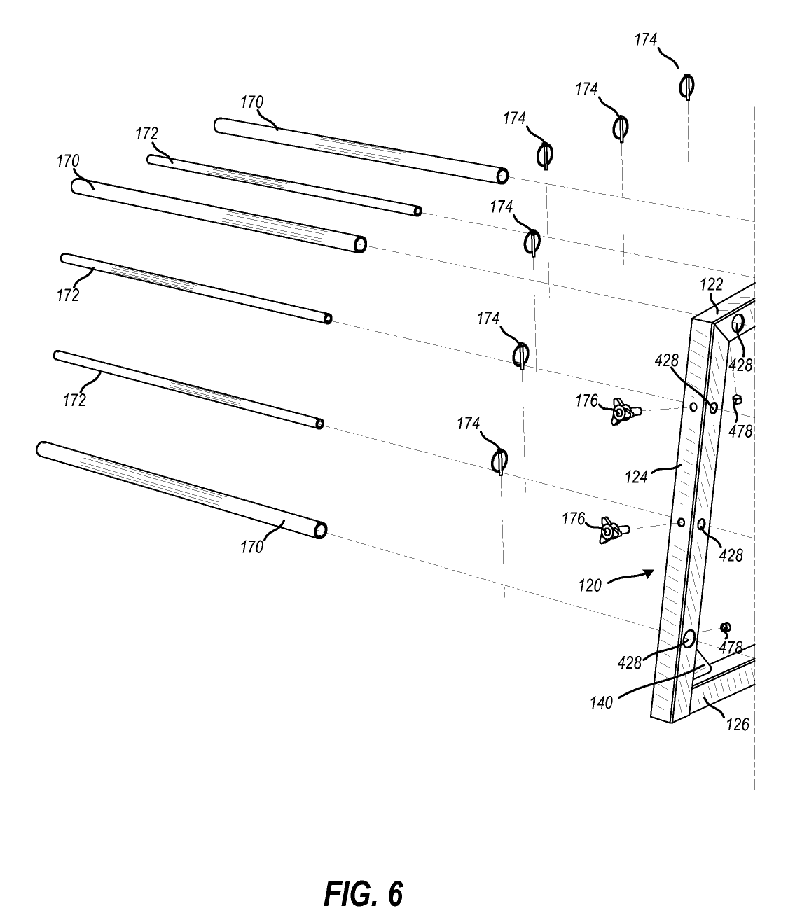

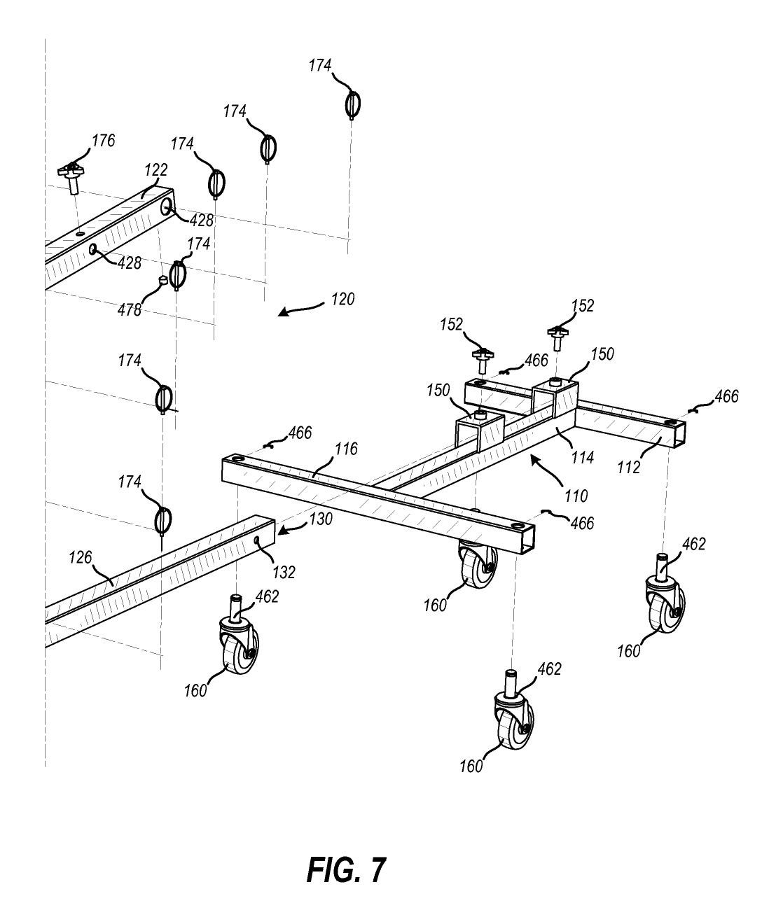

Referring now to FIGS. 1-7, a wire and cable assembly device 100 for selectively dispensing a wire or cable product is shown. The wire and cable assembly device 100 includes an h-frame section 110 and a c-frame section 120. The h-frame section 110 includes front 112, center 114, and back 116 sections. The front 112 and back 116 sections are parallel one to another and are both perpendicular to the center 114 of the h-frame section 110. By way of example, the various sections 112, 114, 116 of the h-frame section 110 can be manufactured with 2″×2″ square tubing with a ⅛ inch wall thickness. However, alternative materials can be utilized. The front 112, center 114, and back 116 sections are integrally formed. By way of example, these components can be welded one to another.

The h-frame section 110 also includes multiple holes 466 for wheels 160 located within the front 112 and back 116 sections. These holes 466 can be one inch in diameter to accommodate a standard caster. By way of example, the h-frame section 110 can be equipped with four wheels 160, two at the front section 112 and two at the back section 116, thus providing for one wheel 160 on each corner wire and cable assembly device 100. This provides easy transportability and moveability of the device through buildings, parking lots, and the like.

The assembly of each wheel 160 also includes a swiveled frame 462 and a retaining ring cap 464 to be attached to the upper part of the swiveled frame as each wheel is assembled into the h-frame section 110 through each hole 466. Alternative wheel assemblies can be utilized with the wire and cable assembly device 100 so long as the wheel assemblies are quickly and easily attachable and removable from the h-frame section 120. The wheels 160 are configured to spin 360 degrees on the swiveled frames 462 and to be selectively locked in place with a brake by a user to prevent overall movement of the wire and cable assembly device 100. Brakes can be utilized on all four wheels 160 or, for example, only on the two back wheels.

The h-frame section 110 also includes two support bridges 150 disposed upon the h-frame center section 114. Each support bridge 150 is equipped with a hand knob 152 threaded through a hole in each top of each support bridge 150. As another component of the wire and cable assembly device 100 is placed through the support bridges 150, the hand knobs 152 are turned and thus tightened to hold that component in place. The hand knobs 152 are easily turned by a user to loosen or tighten the component contained in the support bridges 150. The component contained in the two support bridges 150 is a portion of the c-frame section 120.

The c-frame section 120 includes top 122, center 124, and bottom 126 sections. The top 122, center 124, and bottom 126 sections are integrally formed in the general form of a c-shape. By way of example, these components can be welded one to another. The c-frame section 120 also includes a gusset 140 to provide angled support between the center 124 and bottom 126 sections. By way of example, the center 124 can be disposed in the c-frame section 120 at an 80-degree angle relative to the bottom 126 section. The gusset 140 can be integrally formed with the c-frame section 120. Similarly, a gusset 140 can be utilized at the angle between the top 122 and center 124 sections to provide additional support. By way of example, the various sections 122, 124, 126 of the c-frame section 120 can be manufactured with 2″×2″ square tubing with a ⅛ inch wall thickness. However, alternative materials and dimensions can be utilized. The gusset 140 is a generally triangular-shaped piece provided for support to the c-frame section 120.

The c-frame bottom 126 section is disposed directly upon the h-frame center 114 section and held in place by the plurality of support bridges 150 and tightened by the plurality of hand knobs 152. By way of example, two support bridges 150 disposed upon the h-frame center section 114, can be manufactured with square tubing slightly larger in dimension than the c-frame bottom 126 section to provide space, slidability, and adjustability to the c-frame bottom 126 section as it slides within the two support bridges 150.

The c-frame section 120 also includes a plurality of holes 428 disposed through the c-frame top 122 and c-frame center 124 sections. The plurality of holes 428 are cut all the way through the c-frame top 122 and c-frame center 124 sections and are configured to receive a plurality of support rods 170, 172 of varying diameters. For example, the holes 428 can be approximately ¾ inches in diameter to accommodate a support rod of smaller diameter 172 and can be approximately 1¼ inches in diameter to accommodate a support rod of larger diameter 170. The holes 428 are designed to allow the support rods 170, 172 to fit snuggly and securely with the c-frame section 120. The support rods 170, 172 can be zinc-coated to prevent rust and provide greater durability than non-coated rods.

The c-frame top 122 and center 124 sections also include a multiplicity of threaded inserts, each insert being adjacent to one of the holes 428. The threaded inserts are configured to accommodate either a support rod hex nut 478 or a support rod hand knob 176. A support rod hex nut 478 is generally utilized to secure a support rod of larger diameter 170. The hex nut 478 can be loosened and tightened with a hex tool to add or remove any of the support rods of larger diameter 170 from the c-frame section 120. A support rod hand knob 176 is generally utilized to secure a support rod of smaller diameter 172.

The plurality of support rods 170, 172 each include a snap ring 174 disposed at each end of each support rod 170, 172. The support rods 170, 172 have a pin hole located at each end to receive a pin of the snap ring 174. By way of example, the hole is cut through the support rod 170, 172 at a diameter of approximately 3/16 inches and located approximately in ½ inch from the end of the support rod 170, 172. Once a pin of the snap ring 174 has been placed, the ring portion of the snap ring 174 is flipped over to secure the snap ring in place, and thus hold a spool 180 in place such that the spool 180 freely rotates as a wire or cable product is dispensed but that the spool 180 does not come off the support rod 170, 172.

The support rod of smaller diameter 172 is designed such that it will fit into the inside of a support rod of larger diameter 170. In operation, a user can loosen support rod hand knob 176 and remove the support rod of smaller diameter 172 and place it into the support rod of larger diameter 170. Once a support rod of smaller diameter 172 is placed into a support rod of larger diameter 170, a snap ring 174 secures the support rod of smaller diameter 172 in place. This functionality provides for added compactability in storage and in transportation.

The c-frame section 120 also includes a towing hitch end 130 and a towing hitch end pin hole 132. Use of the towing hitch end 130 provides the wire and cable assembly device 100 with a means for being towed. By way of example, the wire and cable assembly device 100 can be hitched to a motorized vehicle in order to pull a wire or cable product throughout a parking lot installation. The towing hitch end pin hole 132 is, for example, cut at a 9/16 inch diameter to accommodate a standard hitch size. The towing hitch end 130 of the wire and cable assembly device 100 is designed for motorized vehicles that can accommodate a pull load of 500 pounds or greater.

In operation the wire and cable assembly device 100 can be utilized essentially as a kit, wherein a user can assemble and disassemble the device 100 at will for both portability and storage. Assembly of the wire and cable assembly device 100 includes interconnecting and retaining the plurality of wheels 160 to the underside of the h-frame section 110. Assembly of the wire and cable assembly device 100 also includes interconnecting the c-frame section 120 to the h-frame section 110, threading the c-frame bottom 126 section through the plurality of support bridges 150 and tightening the plurality of bridge support hand knobs 152, securing the c-frame section 120 to the h-frame section 110. Assembly of the wire and cable assembly device 100 further includes threading the plurality of spool support rods 170, 172 through a plurality of holes 428 on the c-frame section 120, tightening the larger diameter support rods 170 with a hex nut 478 for each support rod 170, and tightening the smaller diameter support rods 172 with a support rod hand knob 176.

Assembly of the wire and cable assembly device 100 can also include securing the support rods of a larger diameter 170 with the plurality of hex bolts 478, wherein one of the plurality of hex bolts 478 is tightened once one the support rods of a larger diameter 170 is threaded through the c-frame section 120. Assembly of the wire and cable assembly device 100 can also include securing the support rods of a smaller diameter 172 with the plurality of support rod hand knobs 176, wherein one of the plurality of support rod hand knobs 176 is tightened once one of the support rods of a smaller diameter 172 is threaded through the c-frame section 120, thus providing for ease and rapid removal of the support rods of a smaller diameter 172 when not in use to store them within the support rods of a larger diameter 170.

Assembly of the wire and cable assembly device 100 can also include providing a plurality of snap rings 174 configured to hold in place a spool 180 such that the spool 180 freely rotates as a wire or cable product is dispensed but that the spool 180 does not come off the support rod 170, 172 and placing one snap ring 174 at each end of each of the plurality of spool support rods 170, 172 to secure a spool 180.

Disassembly of the wire and cable assembly device 100 is generally achieved by reversing the above process. First, any spools 180 are removed. For storage and transportation purposes, the support rod of smaller diameter 172 is designed such that it will fit into the inside of a support rod of larger diameter 170. In operation, a user can loosen support rod hand knob 176 and remove the support rod of smaller diameter 172 and place it into the support rod of larger diameter 170. Once a support rod of smaller diameter 172 is placed into a support rod of larger diameter 170, a snap ring 174 secures the support rod of smaller diameter 172 in place.

In operation a width of the h-frame section 110 and a width of each of the plurality of support rods 170, 172 is configured and limited such that the wire and cable assembly device 100 freely passes through doorways of standard industry size.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A wire and cable assembly device for selectively dispensing a multiplicity of wire and cable products, the device comprising:
a frame comprising a c-frame section being vertical and an h-frame section being horizontal and upon which the c-frame section perpendicularly is disposed and slidably adjustable, the c-frame section and the h-frame section being separable from one another for portability and storage; and
a plurality of spool support rods disposed throughout the c-frame section for holding spools of wire and cable products for dispensing.

2. The wire and cable assembly device for selectively dispensing a multiplicity of wire and cable products of claim 1, further comprising:
a plurality of support bridges disposed upon the h-frame section configured to receive the c-frame section through the plurality of support bridges;
a plurality of hand knobs, one of the plurality of hand knobs being disposed upon each of the plurality of support bridges;
wherein the h-frame section is further comprised of a front, center, and back section, integrally formed, the plurality of support bridges being disposed upon the h-frame center section;
wherein the c-frame section is further comprised of a top, center, and bottom section and a gusset, integrally formed, and a plurality of holes disposed through the c-frame top and c-frame center sections and within which to receive the plurality support rods; and
wherein the c-frame bottom section is disposed upon the h-frame center section and held in place by the plurality of support bridges and tightened by the plurality of hand knobs.

3. The wire and cable assembly device for selectively dispensing a multiplicity of wire and cable products of claim 2, wherein the c-frame bottom section further comprises:
a towing hitch end for connectivity of the wire and cable assembly device to a motor vehicle, or the like; and
a towing hitch end pin hole configured to receive a hitch pin.

4. The wire and cable assembly device for selectively dispensing a multiplicity of wire and cable products of claim 1, further comprising:
a plurality of wheels, the wheels being disposed on an underside of the h-frame section and secured with a plurality of retaining rings and configured to spin 360 degrees on a swiveled wheel frame and to be selectively locked in place with a brake to prevent overall movement of the wire and cable assembly device.

5. The wire and cable assembly device for selectively dispensing a multiplicity of wire and cable products of claim 1, further comprising:
a plurality of snap rings, one snap ring being disposed at each end of each of the plurality of spool support rods, the snap rings configured to hold in place a spool such that the spool freely rotates as a wire or cable product is dispensed but that the spool does not come off the support rod.

6. The wire and cable assembly device for selectively dispensing a multiplicity of wire and cable products of claim 5, wherein the plurality of spool support rods is comprised of rods of varying diameters such that those rods of a smaller diameter are configured for storage within those rods of a larger diameter, and wherein the snap ring being disposed at each end of each of the plurality of spool support rods prevents a rod of smaller diameter stored within from falling out of the rod of larger diameter.

7. The wire and cable assembly device for selectively dispensing a multiplicity of wire and cable products of claim 6, further comprising:
a plurality of hex bolts utilized to secure the support rods of a larger diameter, wherein one of the plurality of hex bolts is tightened once one the support rods of a larger diameter is threaded through the c-frame section.

8. The wire and cable assembly device for selectively dispensing a multiplicity of wire and cable products of claim 6, further comprising:
a plurality of support rod hand knobs disposed on the c-frame section and utilized to secure the support rods of a smaller diameter, wherein one of the plurality of support rod hand knobs is tightened once one of the support rods of a smaller diameter is threaded through the c-frame section, thus providing for ease and rapid removal of the support rods of a smaller diameter when not in use to store them within the support rods of a larger diameter.

9. The wire and cable assembly device for selectively dispensing a multiplicity of wire and cable products of claim 1, wherein the plurality of spool support rods are zinc-coated to prevent rust and to provide durability.

10. The wire and cable assembly device for selectively dispensing a multiplicity of wire and cable products of claim 1, wherein a width of the h-frame section and a width of each of the plurality of support rods is configured and limited such that the wire and cable assembly device freely passes through doorways of standard industry size.

11. The wire and cable assembly device for selectively dispensing a multiplicity of wire and cable products of claim 1, wherein the c-frame section and the h-frame section are comprised of square tubing members that are integrally formed.

12. The wire and cable assembly device for selectively dispensing a multiplicity of wire and cable products of claim 1, wherein the plurality of spool support rods is comprised of hollow cylindrical metal tubes.

13. The wire and cable assembly device for selectively dispensing a multiplicity of wire and cable products of claim 1, further comprising:
a plurality of spools containing various wire and cable products, each spool placed securely on one of the plurality of support rods.

14. A method for assembling a wire and cable assembly device for selectively dispensing a multiplicity of wire and cable products, the method comprising:
providing an h-frame section comprising a front, center, and back section, integrally formed, a plurality of support bridges disposed upon the h-frame center section configured to receive the c-frame section through the plurality of support bridges, and a plurality of hand knobs, one of the plurality of hand knobs being disposed upon each of the plurality of support bridges;
providing a c-frame section comprising a top, center, and bottom section and a gusset, integrally formed, and comprising a plurality of holes;
providing a plurality of wheels, each of the plurality of wheels configured to spin 360 degrees and to be selectively locked in place to prevent movement of the wire and cable assembly device;
providing a plurality of spool support rods disposed throughout the holes of the c-frame section for holding spools of wire and cable products for dispensing;
interconnecting and retaining the plurality of wheels to the underside of the h-frame section;
interconnecting the c-frame section to the h-frame section, threading the c-frame bottom section through the plurality of support bridges and tightening the plurality of hand knobs, securing the c-frame section to the h-frame section; and
threading the plurality of spool support rods through a plurality of holes on the c-frame section.

15. The method for assembling a wire and cable assembly device for selectively dispensing a multiplicity of wire and cable products of claim 14, further comprising:
providing a c-frame bottom section further comprising a towing hitch end for connectivity of the wire and cable assembly device to a motor vehicle, or the like and a towing hitch end pin hole configured to receive a hitch pin; and
interconnecting the towing hitch end to the motor vehicle.

16. The method for assembling a wire and cable assembly device for selectively dispensing a multiplicity of wire and cable products of claim 14, further comprising:
providing a plurality of snap rings configured to hold in place a spool such that the spool freely rotates as a wire or cable product is dispensed but that the spool does not come off the support rod;
placing one snap ring at each end of each of the plurality of spool support rods to secure a spool.

17. The method for assembling a wire and cable assembly device for selectively dispensing a multiplicity of wire and cable products of claim 14, further comprising:
removing any spools located on the plurality of spool support rods;
removing the plurality of spool support rods from the c-frame section;
disconnecting the c-frame section from the h-frame section; and
storing and/or transporting the wire and cable assembly device

18. The method for assembling a wire and cable assembly device for selectively dispensing a multiplicity of wire and cable products of claim 16, wherein the plurality of spool support rods is comprised of rods of varying diameters such that those rods of a smaller diameter are configured for storage within those rods of a larger diameter, and wherein the snap ring being disposed at each end of each of the plurality of spool support rods prevents a rod of smaller diameter stored within from falling out of the rod of larger diameter.

19. The method for assembling a wire and cable assembly device for selectively dispensing a multiplicity of wire and cable products of claim 18, further comprising:
providing a plurality of hex bolts; and
securing the support rods of a larger diameter with the plurality of hex bolts, wherein one of the plurality of hex bolts is tightened once one the support rods of a larger diameter is threaded through the c-frame section.

20. The method for assembling a wire and cable assembly device for selectively dispensing a multiplicity of wire and cable products of claim 18, further comprising
providing a plurality of support rod hand knobs; and
securing the support rods of a smaller diameter with the plurality of support rod hand knobs, wherein one of the plurality of support rod hand knobs is tightened once one of the support rods of a smaller diameter is threaded through the c-frame section, thus providing for ease and rapid removal of the support rods of a smaller diameter when not in use to store them within the support rods of a larger diameter.
